(19) United States
(12) Patent Application Publication
(10) Pub. No.: US 2015/0292859 A1
(43) Pub. Date: Oct. 15, 2015

(54) ROTARY FOURIER TRANSFORM INTERFEROMETER SPECTROMETER INCLUDING A MULTI-FACETED OPTICAL ELEMENT

(71) Applicant: Finite Element Analyst, Inc., Irvine, CA (US)

(72) Inventor: Eyad Ammari, Irvine, CA (US)

(73) Assignee: Finite Element Analyst, Inc., Irvine, CA (US)

(21) Appl. No.: 14/252,564

(22) Filed: Apr. 14, 2014

(51) Int. Cl. G01B 9/02; G01J 3/453

(52) U.S. Cl. CPC G01B 9/02043; G01B 9/02091; G01J 3/4535

(57) ABSTRACT

This disclosure provides an optical interferometer including a multi-faceted optical element that is rotated to introduce an optical path length difference between two different optical paths in the interferometer. The multi-faceted optical element can be configured to be rotated about an axis such that the optical path length difference between the first and second optical paths varies between a first value and a second value several times during one complete rotation of the optical element. The multi-faceted optical element can be rotationally symmetric having n-fold rotational symmetry. The two different optical paths can be non-coplanar with respect to each other and the multi-faceted optical element can be disposed in one of the optical paths or both the optical paths.

### TECHNICAL FIELD

This disclosure generally relates to an interferometer and particularly to methods and systems for Fourier Transform Interferometeric spectroscopy.

### DESCRIPTION OF THE RELATED TECHNOLOGY

Fourier transform spectroscopy, like other various spectroscopy techniques, is a method for characterizing the spectral content or wavelength distribution of light. Fourier transform infrared spectroscopy (FTIR) is a method for obtaining the spectral distribution of infrared light. A Fourier transform spectrometer can be used to collect electromagnetic radiation, absorbed, transmitted or scattered by the matter over a wide spectral range to determine the wavelength distribution of this light. Accordingly, the wavelength dependency of the absorption, transmission or scatter properties of the matter can be evaluated.

An interferometer, such as, for example a Michelson interferometer can be used in Fourier Transform spectroscopy and in particular FTIR spectroscopy. To obtain a wavelength spectrum, a beam of broadband electromagnetic radiation comprising at least one wavelength component, e.g., in the infrared spectral range, is split into two beams propagating along two different optical paths. The two beams propagating along the two different optical paths are combined and directed towards a detector. A variation in the intensity of the detected light is observed for different values of the optical path difference due to optical interference. The interferometer can be configured to vary at least one of the two optical paths such that the two different paths have an optical path difference that varies with time. The variation in the intensity of light for different values of the optical path difference is referred to as an interferogram. Without subscribing to any theory, in general the intensity of light is maximum in the interferogram for values of optical path difference equal to zero or substantially close to zero and minimum for values of optical path difference that cause the beams to be 180° phase out of phase. A Fourier transform of the interferogram yields the wavelength spectrum and can be obtained by mathematically processing the detected light. A Fourier transform spectrometer, such as a FTIR system, can be used in a wide variety of applications.

### SUMMARY

The systems, methods and devices of this disclosure each have several innovative aspects, no single one of which is solely responsible for the desirable attributes disclosed herein.

One innovative aspect of the subject matter described in this disclosure can be implemented in an optical interferometric device comprising a first optical path comprising a first reflector; a second optical path comprising a second reflector; and a multi-faceted optical element disposed in the first optical path. The multi-faceted optical element is configured to be rotatable about a rotational axis and including a top surface, a bottom surface and a plurality of facets between the top and the bottom. Each of the plurality of facets includes a plurality of edges, each edge having a spatial extent. The multi-faceted optical element has a refractive index characteristic such that an optical path length difference is introduced between electromagnetic radiation propagating along the first optical path and electromagnetic radiation propagating along the second optical path, the optical path length difference increasing from a first value to a second value greater than the first value. The number of the facets of the multi-faceted optical element is n such that the optical path length difference increases from the first value to the second value at least n times during one rotation of the multi-faceted optical element.

Another innovative aspect of the subject matter described in this disclosure can be implemented in an optical interferometric device comprising a first optical path comprising a first reflector; a second optical path comprising a second reflector; and a multi-faceted optical element disposed in the first optical path. The multi-faceted optical element is configured to be rotatable about a rotational axis, a cross-section of the multi-faceted optical element in a plane perpendicular to the rotational axis and/or including the first or the second optical path having a shape that has an n fold rotational symmetry about the rotational axis, wherein n has a value greater than or equal to 2. The multi-faceted optical element has a refractive index characteristic such that an optical path length difference is introduced between electromagnetic radiation propagating along the first optical path and electromagnetic radiation propagating along the second optical path, the optical path length difference increasing from a first value to a second value multiple times during one rotation of the multi-faceted optical element, the second value being greater than the first value as the optical element rotates.

Another innovative aspect of the subject matter described in this disclosure can be implemented in an optical interferometric device comprising a first optical path comprising a first reflector; a second optical path comprising a second reflector, the first and the second optical paths being non-coplanar; and a multi-faceted optical element disposed in the first optical path, the multi-faceted optical element configured to be rotatable about a rotational axis. The multi-faceted optical element has a refractive index characteristic such that an optical path length difference is introduced between electromagnetic radiation propagating along the first optical path and electromagnetic radiation propagating along the second optical path, the optical path length difference varying between a first value and a second value multiple times during one rotation of the multi-faceted optical element, the second value being greater than the first value.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 illustrates an implementation of an interferometer that can be used for FTIR spectroscopy. FIG. 1A is a plot that schematically illustrates an interferogram obtained by the interferometer illustrated in FIG. 1.

FIG. 2A illustrates an implementation of a FTIR spectroscopy system including a first and a second optical path and a multi-faceted optical element disposed in the second optical path but not the first optical path, the multi-faceted optical element is configured to be rotatable about a rotational axis. FIG. 2B illustrates an implementation of the multi-faceted optical element. FIG. 2C depicts an implementation of a multi-faceted optical element as it rotates about a rotational axis. FIG. 2D schematically illustrates the variation in the optical path length difference Ax during one rotation for an implementation of the multi-faceted optical element.

FIGS. 3A-3D illustrate top views of different implementations of the multi-faceted optical element. FIG. 3E shows an implementation of a multi-faceted optical element that can be employed to obtain interferograms with increased SNR and spectral resolution.

FIG. 4A illustrates a top-view of an implementation of a FTIR spectroscopy system including a first and a second optical path and a multi-faceted optical element disposed in the first optical path but not in the second optical path, the multi-faceted optical element is configured to be rotatable about a rotational axis. FIG. 4B illustrates a side-view of the implementation illustrated in FIG. 4A.

FIG. 4C illustrates a perspective view of an implementation of a FTIR spectroscopy system including a first and a second optical path and a multi-faceted optical element disposed in the first optical path but not in the second optical path.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to operate as an optical interferometer and in particular in a Fourier transform infrared/visible spectrum spectroscopy system. The methods and systems described herein can be included in or associated with a variety of devices such as, but not limited to devices used for visible and infrared spectroscopy, devices used for imaging purpose (e.g. Optical coherence tomography (OCT)), devices used for navigation purpose (e.g. gyroscopes), devices used for telecommunication (e.g. receivers and modulators). The teachings are not intended to be limited to the implementations depicted solely in the Figures, but instead have wide applicability as will be readily apparent to one having ordinary skill in the art.

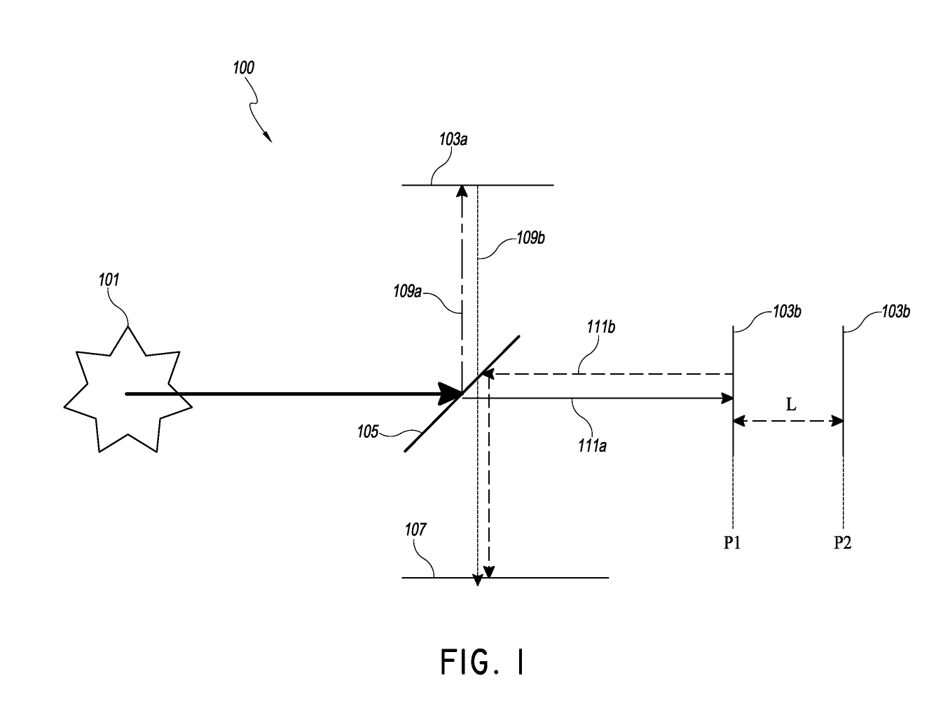

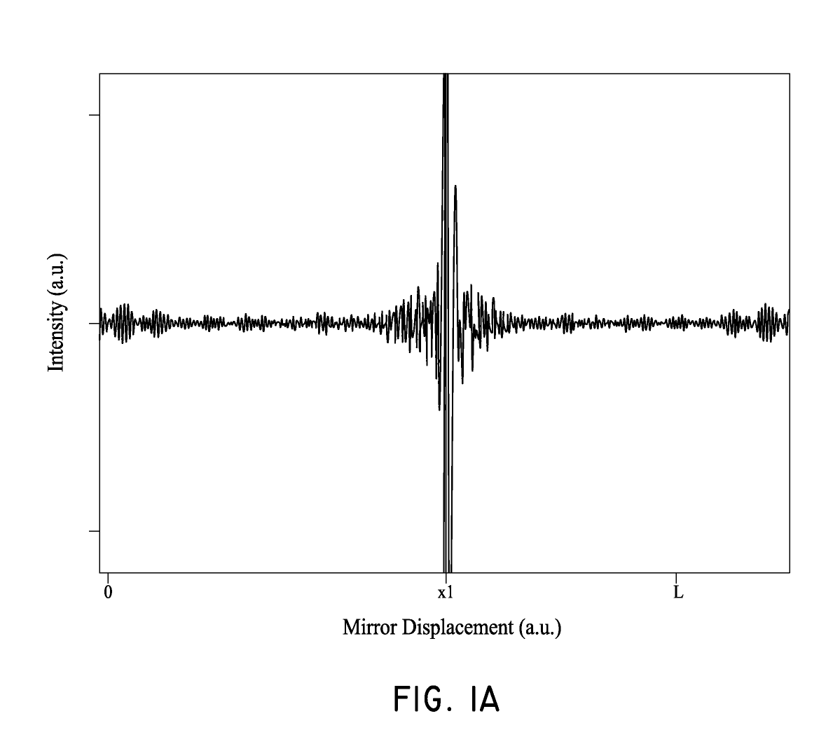

FIG. 1 illustrates an implementation of an interferometer 100 that can be used for FTIR spectroscopy. The depicted implementation 100 includes a partially reflecting beam splitter 105 that is configured to split incident electromagnetic radiation from a source 101 along two different optical paths as rays 109a and 111a. The first optical path extends between the beam splitter 105 and a first reflector 103a and the second optical path extends between the beam splitter 105 and a second reflector 103b. The interferometer 100 may also be considered to have first and second arms, light from which is split then combined and interfered. In the embodiment shown, the first and second optical paths propagate along the first and second arms respectively. In operation, the electromagnetic radiation propagating along the different optical paths are reflected by the reflectors 103a and 103b as rays 109b and 111b, combined at the beam splitter and directed towards a detector 107. The rays 109b and 111b optically interfere with each other at the detector 107 such that the total intensity detected by the detector 107 is a coherent superposition of the two rays 109b and 111b. During optical interference, both the amplitude and the phase of the two reflected rays 109b and 111b contribute to the aggregate intensity detected at the detector 107.

Generally, the optical intensity detected by the detector 107 is a function of the optical path length difference Δx. Without subscribing to any theory if the optical path length difference Δx between two reflected rays 109b and 111b is equal to mλ, where m is an integer having values 0, ±1, ±2, etc., and λ is the wavelength of the electromagnetic radiation, then the intensity of the two rays 109b and 111b add up to increase intensity of the electromagnetic radiation. If the optical path length difference Δx between two reflected rays 109b and 111b equal to ±(2m+1)λ/2, where m is an integer having values 0, ±1, ±2, etc., and λ is the wavelength of the electromagnetic radiation, then the intensity of the two rays 109b and 111b cancel each other to decrease intensity of the electromagnetic radiation. If the optical path length difference Δx and the amplitude of the two light rays 109b and 111b are configured so as to reduce the intensity, then the two light rays are referred to as interfering destructively. If on the other hand, the optical path length difference Δx and the amplitude of the two light rays 109b and 111b are configured so as to increase the intensity, then the two light rays are referred to as interfering constructively. The optical path length difference Δx depends on a number of factors such as refractive index of the medium in which the two rays 109b and 111b propagate, the phase of the two rays 109b and 111b, the wavelength of the two rays 109b and 111b, the physical dimensions of the first and the second optical paths. For incident electromagnetic radiation that is broadband and includes a plurality of wavelengths, different wavelengths would constructively and destructively interfere for a given optical path length difference Δx.

In various implementations, the source 101 can be a coherent source of radiation such as, for example, a laser. In various implementations, the source 101 can be an incoherent source of radiation such as, for example a sodium vapor lamp, a fluorescent lamp, solar radiation, light from astronomical objects, etc. In various implementations, the source 101 can be a narrowband source of radiation such as, for example a monochromatic source that emits radiation including only a single wavelength. In various implementations, the source 101 can be a broadband source of radiation that emits radiation including a plurality of wavelengths. The electromagnetic radiation emitted by the source 101 can include wavelengths in visible and infrared spectral regions.

In various implementations, the beam splitter 105 can include a partially silvered mirror, a dichroic mirror, a double prism or a beam splitter prism cube. In various implementations, the beam splitter 105 can comprise an optical component including a plurality of coatings. Other types of beam splitters can be used in different implementations. In various implementations, the reflectors 103a and 103b can include mirrors and/or retro reflectors, although other types of reflectors can also be used. The second reflector 103b is configured to be movable between a first position P1 and a second position P2 that is separated from the first position P1 by a distance L. In various implementations, the second reflector 103b can be disposed on a motorized support to facilitate the displacement of the second reflector 103b between the first and second position P1 and P2.

In various implementations, the detector 107 can be a semiconductor photodetector that is configured to convert electromagnetic radiation into an electrical signal. In various implementations, the detector 107 can be a charge coupled device (CCD) or CMOS detector arrays.

Electromagnetic radiation from the source 101 propagating along the first optical path as ray 109a is reflected by the reflector 103a as ray 109b and electromagnetic radiation that propagates along the second optical path as ray 111a is reflected by the reflector 103b as ray 111b. The electromagnetic radiation reflected by the reflectors 103a and 103b depicted by rays 109b and 111b are combined at beam splitter 105 and directed towards a detector 107. As the reflector 103b is moved between the first position P1 and the second position P2, an optical path length difference of Δx is introduced between rays 109b and 111b.

For purposes of the discussions provided herein, as the reflector 103b is moved between the first position P1 and the second position P2, the optical path difference Ax will vary resulting in a variation in the optical interference condition between the rays 109b and 111b. As a result of the variation in the optical interference condition, the total intensity of electromagnetic radiation incident on the detector 107 which is a coherent superposition of the two rays 109b and 111b will also vary.

Referring to FIG. 1, as the second reflector moves between the first position P1 and the second position P2, the detector 107 can be configured to obtain the intensity of the combined reflected rays 109b and 111b at several different positions of the movable reflector 103b. Accordingly, the detector 107 can be configured to obtain the intensity of the values of the combined reflected rays 109b and 111b for different positions of the reflector 103b between the first position P1 and the second position P2.

For example, the movable reflector 103b is initially positioned at position P1 such that the optical path length difference Ax between the reflected rays 109b and 111b is approximately ζ1. The intensity I(P1) of the combined reflected rays 109b and 111b is recorded by the detector 107. Next, the movable reflector 103b is displaced by a distance x1 to a position between the first and second positions P1 and P2 such that the optical path length difference Ax between the reflected rays 109b and 111b is approximately 0. The intensity I(x1) of the combined reflected rays 109b and 111b is recorded by the detector 107. Next, the movable reflector 103b is displaced to the second position P2 such that the optical path length difference between the reflected rays 109b and 111b is approximately ζ2. The intensity I(P2) of the combined reflected rays 109b and 111b is recorded by the detector 107. In this manner, the system is configured to record the intensity of the combined reflected rays 109b and 111b at several different positions of the reflector 103b. By plotting the obtained intensity versus optical path length difference Δx for those several different positions, an interferogram is obtained. The interferogram can have several peaks depending on the number of times the condition for constructive interference is met as the optical path length difference Δx. Without subscribing to any particular theory, the intensity of the detected light is highest for optical path length difference Δx approximately equal to 0, since the constructive interference condition is met for all wavelengths in the spectrum of the electromagnetic radiation. Accordingly, an interferogram of a broadband source of radiation generally exhibits a central burst including high values of intensity at values of optical path length difference Δx around 0 as shown in FIG. 1A. Without subscribing to any particular theory, the detected intensity may vary sinusoidally with mirror displacement.

The interferogram can be converted to a spectrum (i.e., a plot of the intensity versus wavelength) by obtaining a Fourier transform of the obtained interferogram. This method of acquiring a spectrum is employed in various embodiments of a Fourier transform spectrometer. In Fourier transform spectroscopy spectra are obtained by applying a Fourier transform to the intensity distribution of the detected electromagnetic radiation extending over different intervals of time or distance which correlate to different optical path lengths. Fourier transform spectroscopy can be applied to different applications such as optical spectroscopy, infrared spectroscopy, nuclear magnetic resonance, magnetic resonance spectroscopic imaging, mass spectrometry and electron spin resonance spectroscopy. A processor that includes algorithms and instructions for performing the Fourier transform can be associated with the detector 107 to convert the interferogram to a spectrum using Fourier transformation. A computer readable memory can be associated with the processor to store the obtained interferogram for processing. The memory can also be configured to store the Fourier transformed data. A display device can be associated with the processor to display the Fourier transform spectrum. The processor can be a part of a computing platform that is configured to be in communication (e.g., wired or wireless connection) with the detector 107. This platform may comprise one or more processors, computers or other computing devices, which may or may not be part of a network.

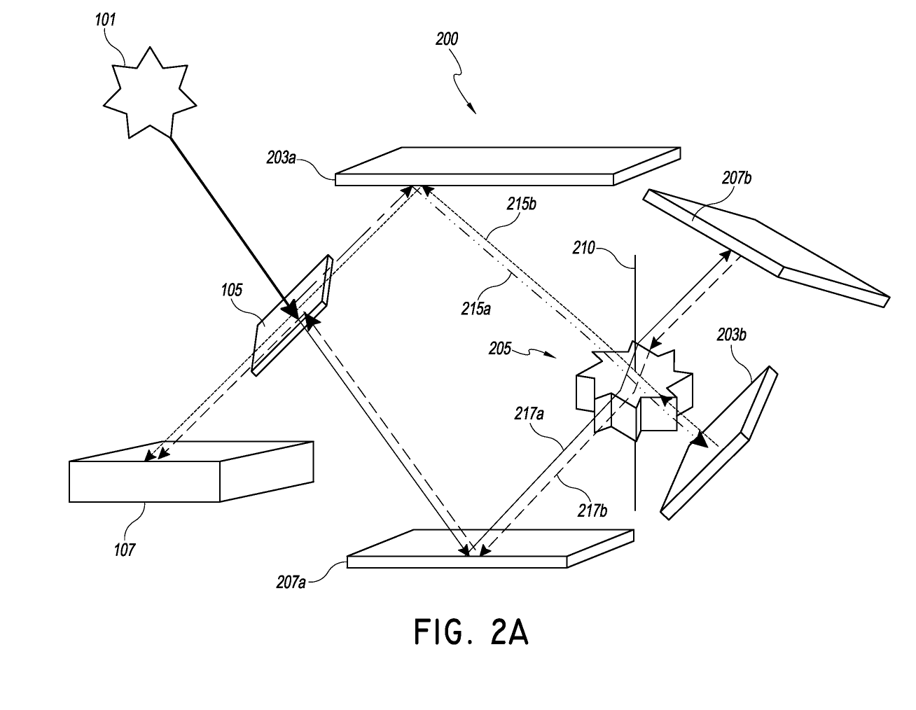

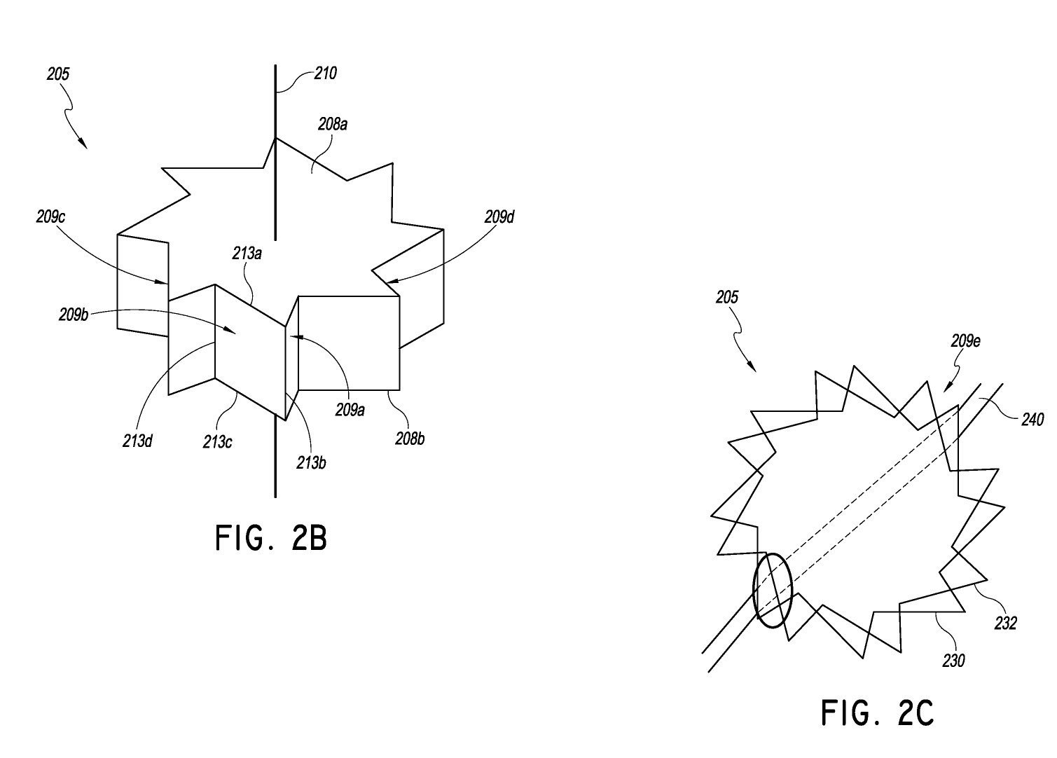

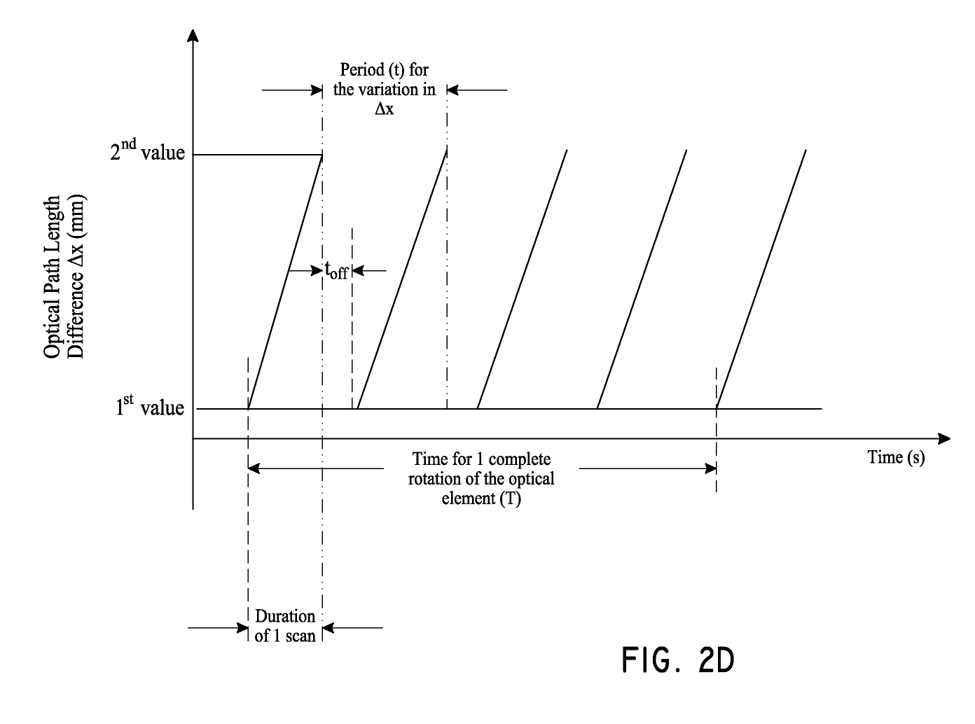

The interferogram is obtained in the space domain (e.g. displacement of the reflector 103b). A Fourier transform of the interferogram, converts the measurement domain into the spectral domain. Thus, in various embodiments, a Fourier transform of the obtained interferogram converts the measurement into the frequency domain, wavelength domain or wavenumber domain. The spectral resolution of an FTIR spectrum obtained by the system and method described above can be proportional to the maximum value of the optical path length difference Δx. It may be desirable to increase the spectral resolution in various implementations of FTIR spectrometers. Accordingly, to obtain a higher resolution of measurement, the reflector 103b could be displaced as far as possible so that the optical path length difference Δx can have a high value. In various implementations, the maximum possible value of the optical path length difference Δx can be limited by coherence length of the radiation emitted by the source 101. In the system described above, it may not be possible to displace the reflector 103b over large distances without introducing tilts and/or vibrations which may result in degrading the output. Or for other reasons large displacements of the reflector 103b may be inconvenient. It may also be desirable to increase the signal-to-noise ratio (SNR) of the output of various implementations of FTIR spectrometers. For a given resolution, the signal-to-noise ratio of the Fourier transformed spectrum can be increased by combining multiple measurements, for example, by averaging. Likewise, the SNR will depend on the number of scans in the measurement interval. Generally, the interferogram obtained by displacing the movable mirror from position P1 to P2 is referred to as a single scan. A second scan is obtained when the mirror is displaced from position P2 to position P1. Accordingly, to increase the signal-to-noise ratio, it may be advantageous to increase the number of scans. The implementations illustrated in FIGS. 2-4E below can have higher SNR and/or higher spectral resolution and/or more complete interferometer scans per unit time as compared to the implementation illustrated in FIG. 1.

FIG. 2A illustrates an implementation of a FTIR spectroscopy system 200 including a first and a second optical path and a multi-faceted optical element 205 disposed in the second optical path but not the first optical path, the multi-faceted optical element 205 is configured to be rotatable about a rotational axis 210 (illustrated in FIG. 2B). The system 200 is configured such that the variation in the optical path difference with time is a due to a variation in the geometrical configuration of the system 200 with time. FIG. 2B illustrates an implementation of the multi-faceted optical element 205. The implementation of the multi-faceted optical element 205 illustrated in FIG. 2A is rotationally symmetric about an axis 210. The first optical path extends between the beam splitter 105 and the reflectors 203a and 203b. The second optical path in the implementation 200 extends between the beam splitter 105 and the reflectors 207a and 207b. Electromagnetic radiation from the source 101 is incident on the beam splitter 105 and split into radiation that propagates along the first optical path and radiation that propagates along a second optical path. In various implementations, mechanisms that can tilt, rotate or displace the reflectors 203a, 203b, 207a and 207b can be provided to optimize the performance of the system 200. In contrast to the implementation 100 illustrated in FIG. 1, the reflectors 203a, 203b, 207a and 207b need not be configured to be translated to sweep through different values of optical path length to obtain an interferogram. Instead, optical path length difference Δx between radiation reflected from the reflectors 203a and 203b represented by rays 215a and 215b and the radiation reflected from reflectors 207a and 207b represented by rays 217a and 217b is varied by rotating the multi-faceted optical element 205 about the axis 210 as discussed in detail below.

In various implementations, the optical element 205 can be configured to be rotatable about the axis 210 by an electric motor (e.g., rotary motor). The motor can be controlled to adjust the speed of rotation of the optical element 205 and thus adjust the scan speed of the system 200 and/or the sampling frequency/rate (e.g., Nyquist frequency). In various implementations, the optical element 205 may be equipped with systems that cause the optical element 205 to be less susceptible to vibrations and irregularities in rotational speeds.

In various implementations, the multi-faceted optical element 205 comprises a material that is transmissive to electromagnetic radiation in the infrared spectral region such as fused silica, calcium fluoride (CaF₂), plexi-glass or acrylate. In various implementations, the multi-faceted optical element 205 can comprise a material that is transmissive to electromagnetic radiation in visible and/or infrared spectral range. The multi-faceted optical element 205 has a top surface 208a (indicated by the shaded region in FIGS. 2A and 2B), a bottom surface 208b opposite the top surface 208a and a plurality of facets (e.g., 209a, 209b, 209c and 209d) between the top and bottom surfaces 208a and 208b. In various implementations, each facet (e.g., 209b) can include a plurality of edges (e.g., 213a, 213b, 213c and 213d). In the implementation illustrated in FIG. 2A, the rays 217a and 217b enter and exit the optical element 205 via a pair of facets that are on opposite sides of a plane including the axis 210 and perpendicular to the top surface 208a of the optical element 205 and whose edges are parallel to each other. In various implementations, the number of facets included between the top surface 208a and the bottom surface 208b is a number that is a multiple of four. In such implementations, half the number of facets is used to obtain an interferogram, while the other half the number of facets is not used to obtain an interferogram unless the interferogram is very short. In various implementations, the facets that are employed to obtain an interferogram can be polished such that light is transmitted without optical defects. In various implementations, the facets that are not employed to obtain an interferogram can be un-polished or have low transmissivity.

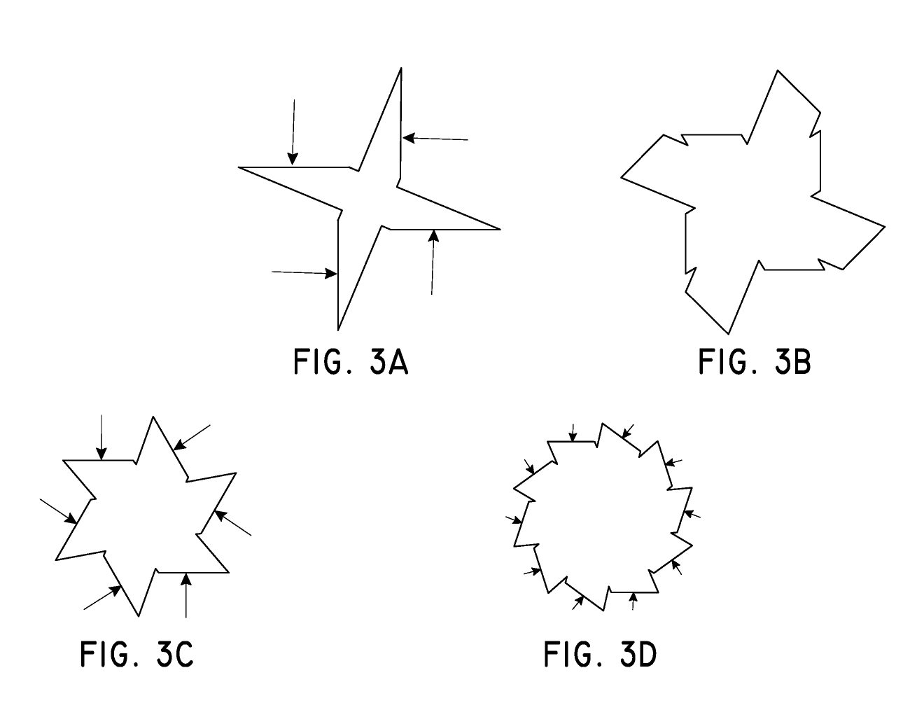

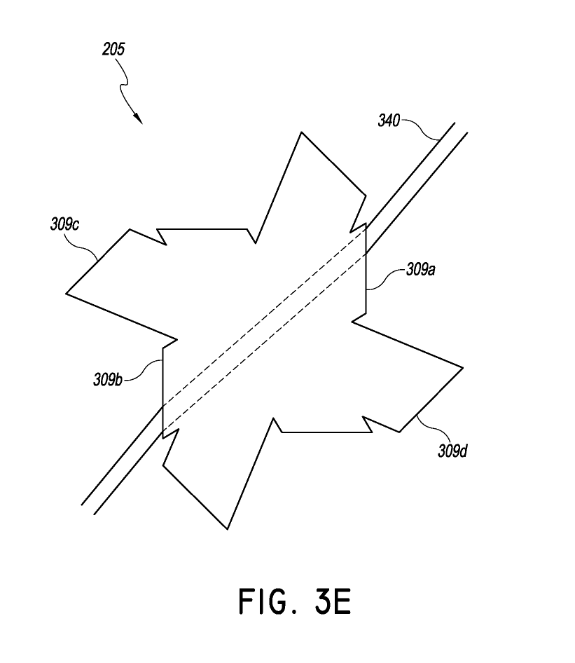

In some implementations, the plurality of facets can be identically shaped and sized. In some implementations, some of the facets can have different shapes and sizes than some other facets. For example, in some implementations, the shape, size (consequently the area) of the facet 209a (and its opposing facet) can be different from the shape, size (and consequently the area) of the facet 209c (and its opposing facet) as explained below with reference to FIG. 3E. In the illustrated implementation of the optical element 205, the facets 209a and 209d are not employed to obtain the interferogram. Facets with different shapes and sizes can be useful to extend the length of the interferometer. Accordingly, facets with different shapes and sizes can be useful to obtain an interferogram over a larger spatial distance. Increasing the spatial distance over which the interferogram is obtained can be useful in increasing the resolution of the interferometer. For example, the optical element can be configured such that the resolution of the interferogram is only limited by the resolution of the source.

The shape of the cross-section of the optical element 205 formed by a plane that is normal to the axis 210 through the optical element and/or that includes one, two, or more of the rays 217a and 217b comprises a plurality of edges equal to the number of facets. For example, if the optical element 205 has eight facets, then the cross-sectional shape of the optical element 205 in the plane that is normal to the axis of rotation 210 and includes both rays 217a and 217b is an octagon including eight edges. Similarly the top surface 208a and bottom surface 208b may be a pentagon or a parallelo-piped. Each of the plurality of edges of the facets can have a spatial extent. In various implementations, the optical element 205 can be configured such that the spatial extents of all the edges of the cross-section of the optical element 205 in the plane normal to the axis of rotation 210 and/or including both rays 217a and 217b are equal. In various implementations, the optical element 205 can be configured such that some of the edges of the cross-section of the optical element 205 in the plane that is normal to the axis of rotation 210 and/or includes both rays 217a and 217b are different from some other edges of the cross-section. In some implementations, some of the edges of the cross-section of the optical element 205 in the plane that is normal to the axis of rotation 210 and/or includes both rays 217a and 217b can have spatial extents that are lesser than or greater than the spatial extents of other of these edges.

In various implementations, the top and bottom surfaces 208a and 208b can be identically shaped, sized and oriented. In other implementations, the bottom surface 208b can be dissimilar from the top surface 208a. The bottom surface 208b is disposed a certain vertical distance below the top surface 208a providing the multi-faceted optical element with thickness for the rays to pass though.

The multi-faceted optical element can be configured such that during operation of the interferometer 200, the multi-faceted optical element 205 is rotated about an axis of rotation 210 that passes through the top and bottom surfaces 208a and 208b and electromagnetic radiation passes through the facets. In various implementations, the number of facets of the multi-faceted optical element 205 can be such that the optical path length difference Δx between the radiation reflected from the reflector 203b and radiation reflected from the reflector 207b varies between a first value and a second value several times in one rotation of the optical element 205. In various implementations, the first value can be lesser than the second value. In various implementations, the first value can correspond to a minimum value of the optical path length difference Δx. In various implementations, the first value can be equal to 0 or approximately 0. In various implementations, the second value can correspond to a maximum value of the optical path length difference Δx. The number of times that the optical path length difference Δx has the first value can be at least equal to the degree of rotational symmetry of the optical element 205. In various implementations, the optical path length difference Δx can have the first value M times in one rotation, where M is equal to the degree of rotational symmetry of the optical element 205.

FIG. 2C illustrates a cross-section of the optical element 205 in a plane that is normal to the axis 210 intersected by an optical beam 240 (e.g. an optical beam including rays 217a and 217b) as it rotates about the axis 210. The initial position of the optical element 205 is indicated by reference numeral 230 and the reference numeral 232 indicates a rotated position of the optical element 205. It is noted from FIG. 2C that the optical beam 240 intersects the optical element 205 at different positions of the facet 209e for the initial and rotated positions. Accordingly, the distance travelled by the optical beam 240 through the optical element 205 in the initial position represented by reference numeral 230 is different from the distance travelled by the optical beam 240 through the optical element 205 in the rotated position 232. For example, in the implementation illustrated in FIG. 2C, the distance travelled by the optical beam 240 through the optical element 205 in the initial position represented by reference numeral 230 is greater than the distance travelled by the optical beam 240 through the optical element 205 in the rotated position represented by reference numeral 232. Accordingly, as the optical element 205 rotates the distance traversed by rays 215a and 217a (and consequently 215b and 217b) through the optical element 205 varies. Thus, the first and second optical path lengths are varied as the optical element 205 rotates. If the variation in the first and second optical path lengths is the same, then the optical path length difference Δx would be constant or change negligibly. However, if the variation in the first optical path length is different from the variation in the second optical length as the optical element 205 rotates, then the optical path length difference Δx between the first and second optical paths also varies as the optical element 205 rotates.

FIG. 2D schematically illustrates the variation in the optical path length difference Δx during one rotation for an implementation of the multi-faceted optical element 205. Without subscribing to any particular theory, the variation in the optical path length difference Δx is periodic within a time period, T, for one complete rotation of the optical element 205. The periodicity, t, of the variation in the optical path length difference Δx can depend on the degree of rotational symmetry of the optical element 205. For example, if the optical element 205 has a four-fold rotational symmetry about the rotational axis 210, then the optical path length difference Δx would vary from a first value (1^{st} value) to a second value (2^{nd} value) periodically such that the optical path length transitions (e.g., increase) from a first value (1^{st} value) to the second value (2^{nd} value) four times in one complete rotation of the optical element 205, as shown in FIG. 2D or at least four times in one complete rotation of the optical element 205. As another example, if the optical element 205 has a K-fold rotational symmetry about the rotational axis 210, then the optical path length difference Δx would vary between the first value and the second value periodically such that the optical path length difference Δx transitions (e.g. increases) from the first value to the second value at least K times in one complete rotation of the optical element 205. In various implementations, the first value can be lesser than the second value. In various implementations, the system 200 can be configured such that the first value is approximately 0. In various implementations, the optical element 205 can be configured such that the optical path length difference Δx varies between 0 and 0.1 cm; or 0 and 0.2 cm; or 0 and 0.5 cm; or 0 and 1.0 cm; or 0 and 2.0 cm; or 0 and 5.0 cm; or 0 and 10.0 cm or more. For example, the dimensions of the edges of the various facets of the optical element 205 can be selected such that optical path length difference Δx varies between 0 and 0.1 cm; or 0 and 0.2 cm; or 0 and 0.5 cm; or 0 and 1.0 cm; or 0 and 2.0 cm; or 0 and 5.0 cm; or 0 and 10.0 cm or more.

In various implementations, the optical path length difference Δx between the first and the second optical paths may not be recorded for a period of time t_{off} as shown in FIG. 2D. The time period t_{off} corresponds to a time gap between two consecutive scans when the optical path length difference is not recorded. For example, when the multi-faceted optical element 205 has a shape as shown in FIGS. 2A-2C and 3A-3E, then the optical path length difference Δx between the first and the second optical paths may not be recorded when the first or the second optical path intersects those facets (e.g., 209a and 209d) that are not employed to obtain the interferogram.

In general, the resolution of the spectrum obtained by the system 200 depends on the amplitude (A) of the variation of the optical path length difference Δx. Without subscribing to any particular theory, for the system 200 illustrated in FIG. 2A, the amplitude (A) of the variation of the optical path length difference Δx can depend on a number of factors including but not limited to a) the spatial extent of the plurality of edges of the facets; b) the degree of rotational symmetry of the facets; c) the difference in the spatial extents of adjacent edges of the facets, etc. Accordingly, to increase spectral resolution, it may be advantageous to increase the amplitude of the variation of the optical path length difference Δx. One approach to increase the amplitude (A) of the variation of the optical path length difference Δx can be to configure the optical element 205 such that adjacent edges of the facets have unequal spatial extents.

In various implementations, the multi-faceted optical element 205 can be rotationally symmetric about the rotational axis. For example, the multi-faceted optical element 205 can have n-fold rotational symmetry, wherein n can have a value between 2 and 20 or more if space permits. For an optical element 205 with n-fold rotational symmetry, the optical path length difference Δx has a minimum or maximum value at least n times during one complete rotation of the optical element 205. For example, the cross-section of the optical element 205 in a plane perpendicular to the optical axis 210 and/or including the one, two, three, or more of rays 215a, 215b, 217a and 217b can be configured as a skewed octagon having eight identically sized edges such that the optical element 205 has eight-fold rotational symmetry about the axis 210. In such an implementation, the optical path length difference Δx achieves the minimum value or the maximum value at least eight times during one complete rotation of the optical element 205. In the implementation illustrated in FIGS. 2A-2C, the optical element 205 has an 8-fold rotational symmetry. In various implementations, as shown in FIGS. 3A-3D, the rotational symmetry of the optical element 205 can be different from 8, for example, 2, 4, 6, 10, 12, 14, 16, 18 or 20.

FIGS. 3A-3D illustrate top views of different implementations of the multi-faceted optical element 205 that are rotationally symmetric. The multi-faceted optical element 205 can have a shape similar to a pinwheel or a star. In various implementations, the multi-faceted optical element 205 can have several protrusions and indentations. The lengths of the protrusions can be equal in some implementations and unequal in some other implementations. The multi-faceted optical element 205 can have a 4-fold rotational symmetry as shown in FIGS. 3A and 3B. The element 205 can have a 6-fold rotational symmetry as shown in FIG. 3C. The element 205 can have a 10-fold rotational symmetry as shown in FIG. 3D. Implementations, of the multi-faceted optical element 205 can be concave polygons that can be rotationally symmetric or rotationally asymmetric.

In various implementations, the multi-faceted optical element can be a skewed square pyramid or a skewed cube having 4-fold rotational symmetry, a parallelepiped having two 2-fold rotational symmetry, etc. In various implementations, the cross-section of the optical element 205 in a plane perpendicular to the optical axis 210 and/or including one, two, three, or more of the rays 215a, 215b, 217a and 217b can have a shape that has an n-fold rotational symmetry. For example, the shape of the cross-section of the optical element 205 in a plane perpendicular to the optical axis 210 and/or including one, two, three, or more of the rays 215a, 215b, 217a and 217b of the optical element 205 can be a parallelepiped having a 4-fold rotational symmetry, a skewed hexagon (for example, saw tooth edge as shown in FIG. 3D) having 6-fold rotational symmetry, or a skewed octagon (e.g., having a saw tooth edge) having 8-fold rotational symmetry. In various implementations, the shape of the forward surface 208a and the rearward surface 208b of the optical element 205 can be a skewed decagon (e.g., having a saw tooth edge) having 10-fold rotational symmetry, or a skewed (e.g., a saw tooth edge) dodecagon having 12-fold rotational symmetry.

Without subscribing to any particular theory, the signal-to-noise ratio (SNR) of the system 200 depends on the number of scans obtained per rotation of the system 200. In the system 200 illustrated in FIG. 2A, the number of scans obtained per rotation of the optical element 205 can be directly proportional to the number of times the optical path length difference Δx has a value equal to 0 or close to 0. In various implementations, the number of times the optical path length difference Δx has a value equal to 0 or close to 0 or a minimum value can depend on the degree of rotational symmetry and/or the shape and size of the optical element 205. Accordingly, to increase the SNR, it may be desirable to (i) increase the number of facets; and/or (ii) increase the degree of rotational symmetry of the optical element. One way to increase the degree of rotational symmetry can be to choose an optical element wherein the cross-sectional shape of the optical element 205 in a plane perpendicular to the optical axis 210 and/or including one, two, three, or more of the rays 215a, 215b, 217a and 217b is an N-sided polygon. As the value of N increases, the potential degree of rotational symmetry also increases.

For example, the implementation of the multi-faceted optical element 205 illustrated in FIG. 3E (and FIG. 3B) is configured to obtain an interferogram with increased spectral resolution and SNR. FIG. 3E shows the orientation of the optical element 205 in an initial position. In the initial position shown in FIG. 3E, an optical beam 340 (e.g., an optical beam including rays 217a and 217b shown in FIG. 2A) intersects the optical element 205 at facets 309a and 309b. Another optical beam (e.g., an optical beam including rays 215a and 215b shown in FIG. 2A) can intersect the optical element 205 at facets 309c and 309d in the initial position. As the multi-faceted optical element 205 illustrated in FIG. 3E is rotated about an axis about which the optical element 205 is rotationally symmetric, the amplitude of the variation of the optical path length difference Δx between the first and second optical beams can be large as the distance travelled by the optical beam 340 varies between a minima corresponding to the distance between facets 309a and 309b and a maxima corresponding to the largest distance between facets 309c and 309d such that the SNR of the interferogram is increased above a threshold value. Furthermore, as the multi-faceted optical element 205 illustrated in FIG. 3E is rotated about an axis about which the optical element 205 is rotationally symmetric, a plurality of scans can be obtained per rotation of the optical element 205 such that the spectral resolution of the interferogram is also increased above a threshold value.

In another implementation, in the initial position shown in FIG. 3E, the optical beam 340 (e.g., an optical beam including rays 217a and 217b shown in FIG. 2A) intersects the optical element 205 at facets 309a and 309b. Another optical beam (e.g., an optical beam including rays 215a and 215b shown in FIG. 2A) does not intersect the optical element 205 but is instead reflected by a mirror and returned to the system unchanged. As the multi-faceted optical element 205 illustrated in FIG. 3E is rotated about an axis about which the optical element 205 is rotationally symmetric, the amplitude of the variation of the optical path length difference Δx between the first and second optical beams is increased. Then, the acquisition system stops recording the interference signal resulting from the variation in the optical path length difference between the optical beam 340 and the other optical beam until the optical beam 340 intersects element 205 at facet 309c and exits through facet 309d. Similar to other implementations, optical beam 340 and the other optical beam are combined at beam splitter 105 and directed to a detector. The detector acquisition system acquires data as the beam travels along facets 309c and 309d. In this implementation, the distances between the pair of facets 309a and 309b and the pair of facets 309c and 309d can be adjusted to increase the length of the interferogram. For example, the interferogram obtained by employing an optical element 205 as shown in FIG. 3E can be at least twice as long as the interferogram obtained from a rotary Michelson interferometer. Accordingly, the resolution of the spectrum obtained by using an interferometer based on the principles discussed above can be increased by at least a factor of two over a rotary Michelson interferometer.

Furthermore, as the multi-faceted optical element 205 illustrated in FIG. 3E is rotated about an axis about which the optical element 205 is rotationally symmetric, a plurality of scans can be obtained per rotation of the optical element 205 such that the SNR of the interferogram is also increased above a threshold value in the same time it takes a rotary Michelson interferometer to perform 4 lower resolution scans. Accordingly, an interferometer based on the principles discussed above can advantageously obtain an interferogram with increased spectral resolution and SNR.

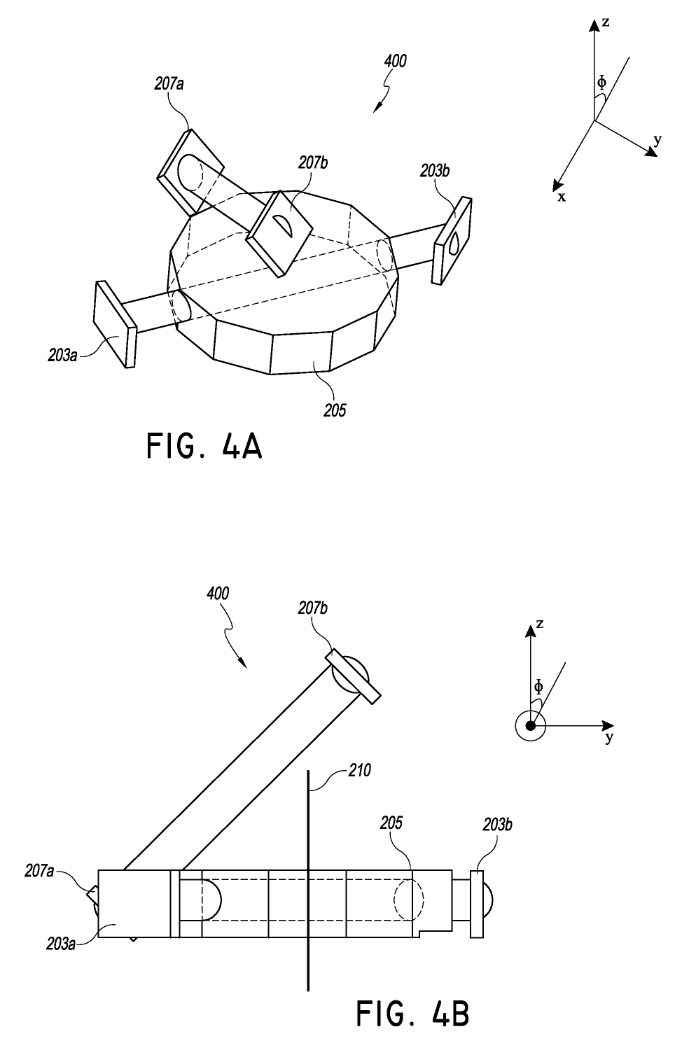

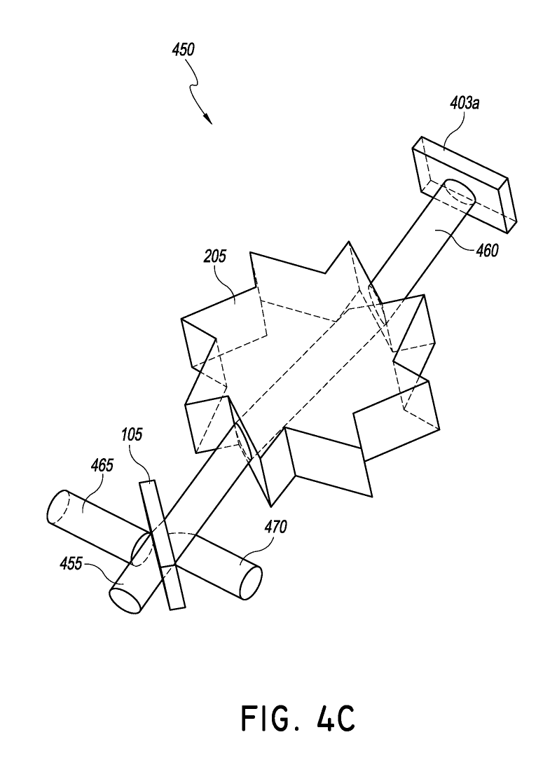

FIG. 4A illustrates a top-view of an implementation of a Fourier transform spectrometer system 400 based on system 200. FIG. 4B illustrates a side-view of the implementation illustrated in FIG. 4A. As discussed with reference to FIG. 2, the multi-faceted optical element 205 is configured to be rotatable about a rotational axis. The optical element 205 is disposed in one of the first or second optical paths and not both. Since, the optical element 205 is disposed in one of the first or second optical paths, the first and second optical paths can be non-coplanar as depicted in FIGS. 4A and 4B. For example, the first reflector 203a, the second reflector 203b and the optical element 205 can be disposed such that the axis of rotation 210 of the optical element is along a direction parallel to the z-axis and a portion of the first optical path is in a first plane orthogonal to the axis of rotation 210 (or a plane parallel to the x-y plane). The reflector 207b can be disposed out of the first plane such that a portion of the second optical path is non-coplanar with respect to the first optical path as illustrated in FIGS. 4A and 4B. In various implementations, the second optical path can be non-coplanar and angled with respect to the first optical path and subtend a non-zero angle φ with respect to the z-axis. The configuration in which the first and second optical paths are non-coplanar can be advantageous in achieving a compact and rugged system that is less susceptible to destabilization due to vibrations.

FIG. 4C illustrates a perspective view of an implementation of a FTIR spectroscopy system 450 including a first and a second optical path and a multi-faceted optical element 205 disposed in the first optical path but not in the second optical path. In the FTIR system 450, an incident beam of light 455 is incident on a first surface of the beam splitter 105 and is divided into a first optical beam 460 and a second optical beam 465. The first optical beam 460 passes through the optical element 205 towards a first reflector 403a, undergoes a reflection at the reflector 403a, passes through the optical element 205 and is incident on a second surface opposite the first surface of the beam splitter 105. The second optical beam 465 is reflected by a second reflector (not shown) and is combined with the first optical beam 460 at the beam splitter 105. The combined optical beam 470 is directed towards a photo detector (not shown). The reflector 403a is a fixed reflector and not capable of movement. The optical element 205 can be similar to the implementations of the optical element illustrated in FIGS. 2A and 3A-3E. The optical path difference between the first optical beam 460 and the second optical beam 465 is varied by rotating the optical element 205 such that the intensity of the optical signal detected by the photo detector varies between a first and a second value.

In various implementations, an optical attenuator can be disposed in the second optical path to compensate for the optical loss that may be incurred by the radiation propagating along the first optical through the multi-faceted optical element 205 such that the optical powers in the first and second optical paths are matched.

The systems 200 and 400 illustrated in FIGS. 2A, 4A, 4B and 4C can be advantageous over the system illustrated 100 illustrated in FIG. 1 since it may be easier to increase the maximum optical path length difference Δx thereby increasing the spectral resolution of the device. For example, spectral resolution of the systems 200 and 400 can be increased by increasing the length of the facets. Additionally, in contrast to the implementation illustrated in FIG. 1, rotating the multi-faceted optical element 205 can allow for increasing the maximum optical path length difference Δx with reduced vibrations or tilts as compared to a rotary Michelson interferometer. Furthermore, the systems 200 and 400 can be configured to obtain a larger number of scans per second as compared to the system 100 or a rotary Michelson interferometer, which can advantageously increase the SNR. For example, more scans can be obtained for every rotation of the optical element 205 by increasing the number of facets. Furthermore, increasing the number of facets can increase the stability of the optical element 205 such that the optical element presents a balanced load to the rotor. This in turn can reduce vibrations during rotation of the optical element 205.

The systems and methods described herein can be used with Fourier transform spectroscopy to obtain a wavelength spectrum with increased resolution and signal-to-noise ratio. Although, the systems and methods are discussed herein with reference to Fourier transform infrared spectroscopy, they are also applicable to instruments, devices and method that measure wavelengths in ranges other than infrared. Various Implementations of the systems and methods described herein can also realize a compact interferometer that can be used in a variety of applications. Additionally, various implementations of the systems and methods described herein can be used to achieve a rugged interferometer that is less susceptible to vibrations. Various implementations of an interferometer described herein comprise two different optical paths (or arms) between two or more reflectors. The different optical paths can be coplanar or non-coplanar. In various implementations, a multi-faceted optical element is disposed such that it is included in one and/or both the optical paths. The multi-faceted optical element is configured to be rotatable about an axis of rotation such that an optical path length difference is introduced between electromagnetic radiation that is propagating along the two different optical paths. The optical path length difference varies between a first value and a second values as the multi-faceted optical element rotates about the rotational axis. Depending on the geometry of the multi-faceted optical element, the optical path length difference can attain the first and second values multiple times during one complete rotation of the multi-faceted optical element.

As used herein, a phrase referring to “at least one of a list of” items refers to any combination of those items, including single members. As an example, “at least one of: a, b, or c” is intended to cover: a, b, c, a-b, a-c, b-c, and a-b-c.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An optical interferometric device comprising:
a first optical path comprising a first reflector;
a second optical path comprising a second reflector; and
a multi-faceted optical element disposed in the first optical path, the multi-faceted optical element configured to be rotatable about a rotational axis and including a top surface, a bottom surface and a plurality of facets between the top and the bottom, the facets including a plurality of edges, each edge having a spatial extent,
wherein the multi-faceted optical element has a refractive index characteristic such that an optical path length difference is introduced between electromagnetic radiation propagating along the first optical path and electromagnetic radiation propagating along the second optical path, the optical path length difference increasing from a first value to a second value greater than the first value, and
wherein the number of the facets of the multi-faceted optical element is n such that the optical path length difference increases from the first value to the second value at least n times during one rotation of the multi-faceted optical element.

2. The device of claim 1, wherein at least one of the first and second reflectors is a retro-reflector.

3. The device of claim 1, wherein at least one of the first and second reflectors is a mirror.

4. The device of claim 1, wherein the number of facets of the multi-faceted optical element is greater than 4.

5. The device of claim 1, wherein the first value of the optical path difference is approximately 0 for electromagnetic radiation in a wavelength range that spans the visible spectral range.

6. The device of claim 1, wherein the first value of the optical path difference is approximately 0 for electromagnetic radiation in a wavelength range that spans the infrared spectral range.

7. The device of claim 1, wherein the electromagnetic radiation has a wavelength in the visible spectrum.

8. The device of claim 1, wherein the electromagnetic radiation has a wavelength in the infrared spectrum.

9. The device of claim 1, wherein spatial extent of each of the plurality of edges is such that a spectral resolution of the device is between 0.0001 cm⁻¹ and 10 cm⁻¹.

10. The device of claim 1, wherein the multi-faceted optical element includes a material that is transmissive to electromagnetic radiation in the visible and infrared spectral ranges.

11. The device of claim 1, wherein the second optical path includes the multi-faceted optical element.

12. The device of claim 1, wherein the second optical path is non-coplanar with the first optical path.

13. The device of claim 12, wherein an attenuating optical element is disposed in the second optical path.

14. The device of claim 1, wherein a cross-sectional shape of the multi-faceted optical element in a plane perpendicular to the rotational axis and/or including the first or second optical path is configured to introduce an optical path length difference between electromagnetic radiation propagating along the first optical path and electromagnetic radiation propagating along the second optical path, the optical path length difference varying from a first value to a second value multiple times during one rotation of the multi-faceted optical element, the second value being greater than the first value as the optical element rotates.

15. The device of claim 1, wherein a cross-sectional shape of the multi-faceted optical element in a plane perpendicular to the rotational axis is a concave polygon.

16. The device of claim 1, further comprising a beam splitter configured to split electromagnetic radiation from a source into electromagnetic radiation that propagates along the first optical path and electromagnetic radiation that propagates along the second optical path.

17. The device of claim 16, wherein the beam splitter is configured to combine electromagnetic radiation that propagates along the first optical path and electromagnetic radiation that propagates along the second optical path and direct the combined electromagnetic radiation towards a detector.

18. The device of claim 1, further comprising a housing including the multi-faceted optical element, the first reflector and the second reflector.

19. The device of claim 1, further comprising a device configured to rotate the multi-faceted optical element about the rotational axis.

20. The device of claim 1, wherein the device is configured to rotate the multi-faceted optical element about the rotational axis at least 200 times per second.

21. The device of claim 1, wherein the multi-faceted optical element has a n fold rotational symmetry about the rotational axis, wherein n has a minimum value of 2 and can increase to any even value that the system space allows.

22. The device of claim 1, wherein the first and the second optical path intersect the multi-faceted optical element.

23. The device of claim 1, wherein the first optical path intersects the multi-faceted optical element but the second optical path does not intersect the optical element.

24. A Fourier transform interferometer spectroscopy system comprising:
the device of claim 1;
a photodetector; and
a processor configured to process the detector output into a spectrum.

25. An optical interferometric device comprising:
a first optical path comprising a first reflector;
a second optical path comprising a second reflector; and
a multi-faceted optical element disposed in the first optical path, the multi-faceted optical element configured to be rotatable about a rotational axis, a cross-section of the multi-faceted optical element in a plane perpendicular to the rotational axis and/or including the first or the second optical path having a shape that has an n fold rotational symmetry about the rotational axis, wherein n has a value greater than or equal to 2, and
wherein the multi-faceted optical element has a refractive index characteristic such that an optical path length difference is introduced between electromagnetic radiation propagating along the first optical path and electromagnetic radiation propagating along the second optical path, the optical path length difference increasing from a first value to a second value multiple times during one rotation of the multi-faceted optical element, the second value being greater than the first value as the optical element rotates.

26. The device of claim 25, wherein n is a multiple of 2 and only limited by the space constraints of the system.

27. The device of claim 25, wherein the second optical path is non-coplanar with the first optical path.

28. The device of claim 27, wherein the first reflector, the second reflector, and the optical element are disposed such that the rotational axis is along a direction parallel to the z-axis and a portion of the first optical path is in the plane of the optical element.

29. The device of claim 24, wherein the second optical path subtends a non-zero angle φ with respect to the z-axis.

30. A Fourier transform interferometer spectroscopy system comprising:
the device of claim 25;
a photodetector; and
a processor configured to process the detector output into a spectrum.

31. An optical interferometric device comprising:
a first optical path comprising a first reflector;
a second optical path comprising a second reflector, the first and the second optical paths being non-coplanar; and
a multi-faceted optical element disposed in the first optical path, the multi-faceted optical element configured to be rotatable about a rotational axis,
wherein the multi-faceted optical element has a refractive index characteristic such that an optical path length difference is introduced between electromagnetic radiation propagating along the first optical path and electromagnetic radiation propagating along the second optical path, the optical path length difference varying between a first value and a second value for each rotation of the multi-faceted optical element, the second value being greater than the first value.

32. The device of claim 31, wherein the multi-faceted optical element has a n fold rotational symmetry about the rotational axis, wherein n is a multiple of 2 and is only limited by the size of the system.

33. A Fourier transform interferometer spectroscopy system comprising:
the device of claim 32;
a photodetector; and
a processor configured to process the detector output into a spectrum.

34. The device of claim 31, further comprising an optical attenuator in the second optical path such that the optical power in the first and second optical paths is matched.

35. The device of claim 31, wherein a cross-sectional shape of the multi-faceted optical element in a plane perpendicular to the rotational axis has a saw-toothed edge.
